(19) United States
(12) Patent Application Publication
(10) Pub. No.: US 2024/0335061 A1
(43) Pub. Date: Oct. 10, 2024

(54) Single Serve Capsule for Preparing a Beverage with the Aid of a Beverage Preparation Machine, and Use of a Single Serve Capsule

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE)

(21) Appl. No.: 18/580,018

(22) PCT Filed: Aug. 1, 2022
(86) PCT No.: PCT/EP2022/071513

§ 371 Date: Jan. 17, 2024

Related U.S. Application Data
(60) Provisional application No. 63/227,708, filed on Jul. 30, 2021.

(30) Foreign Application Priority Data
Aug. 12, 2021 (DE) 10 2021 208 859.7
Aug. 16, 2021 (DE) 10 2021 208 958.5
Dec. 16, 2021 (DE) 10 2021 214 547.7

(51) Int. Cl. A47J 31/44; B65D 85/804

(52) U.S. Cl. CPC A47J 31/4492; B65D 85/804; B65D 85/8058

(57) ABSTRACT

A single serve capsule for preparing a beverage with aid of a beverage preparation machine, the single serve capsule having a base element with a cavity for receiving a beverage raw material and a capsule lid which closes the cavity; the base element including a capsule base, an encircling flange, and a capsule wall which extends from the capsule base to the encircling flange; the capsule lid being fastened to the flange; the single serve capsule having an optically detectable feature which is optically detectable by a detector of the beverage preparation machine; the optically detectable feature being disposed on a side of the capsule lid facing away from the flange, the flange and the capsule lid are configured to be optically transparent at least in a region of the optically detectable feature.

### CROSS REFERENCE TO RELATED APPLICATIONS

This is a US National Stage of PCT/EP2022/071513 filed Aug. 1, 2022, which claims priority to U.S. 63/227,708 filed Jul. 30, 2021; DE 10 2021 208 859.7 filed Aug. 12, 2021; DE 10 2021 208 958.5 filed Aug. 16, 2021; and DE 10 2021 214 547.7 filed Dec. 16, 2021, all of which are hereby incorporated by reference herein for all purposes.

### FIELD

The present invention proceeds from a single serve capsule for preparing a beverage with the aid of a beverage preparation machine, the single serve capsule having a base element with a cavity for receiving a beverage raw material, and a capsule lid which closes the cavity; the base element comprising a capsule base, an encircling flange, and a capsule wall which extends from the capsule base to the encircling flange; the capsule lid being fastened to the flange; the single serve capsule having a feature which is optically detectable in particular by a detector of the beverage preparation machine.

### BACKGROUND

Such single serve capsules are known from the prior art. For example, publication WO 2016/186 488 A1 discloses such a generic single serve capsule. This single serve capsule is provided to be placed in a brewing chamber in which the single serve capsule is perforated so as to direct brewing liquid in the form of pressurized hot water into the cavity. A beverage is created as a result of the interaction between the introduced water and the beverage raw material, in particular roasted and ground coffee, the beverage exiting the single serve capsule by way of further perforated locations and making its way into a vessel.

For each single serve capsule there is typically a matching beverage preparation machine which is optimized for preparing beverages based on the matching single serve capsule. For the avoidance of malfunctions, it has proven successful to provide single serve capsules of this type with detectable features that are optically readable by a machine in such a way that a verification as to whether the inserted single serve capsule is compatible with the machine can take place prior to the beginning of the brewing process. Optionally, a matching brewing program for the beverage raw material located in the single serve capsule can moreover be started.

From publications EP 3 023 362 B1, WO 2020/201 487 A1 and U.S. Pat. No. 10,800,600 B2 it is known to print such optically detectable features in the form of bar codes or binary codes onto the flange of the capsule.

### SUMMARY

It is an object of the present invention to make available a single serve capsule having an optically detectable feature (hereunder also referred to only as feature) of the type mentioned at the outset, which represents an improvement in comparison to the solutions known from the cited prior art. It is the intention in particular for the detectable feature to be easier to apply to the single serve capsule during the production of the single serve capsule. In addition, it is desirable for the feature to be able to be read not only by a detector directed at the lid film so that it provides more options for the configuration of the beverage preparation machine.

The object of the present invention is achieved by a single serve capsule as disclosed herein.

Advantageous design embodiments and refinements of the invention can be derived from the disclosure herein and the following description with reference to the drawings.

Disclosed is a single serve capsule for preparing a beverage with the aid of a beverage preparation machine, the single serve capsule having a base element with a cavity for receiving a beverage raw material, and a capsule lid which closes the cavity; the base element comprising a capsule base, an encircling flange and a capsule wall which extends from the capsule base to the encircling flange; the capsule lid being fastened to the flange; the single serve capsule having a feature which is optically detectable in particular by a detector of the beverage preparation machine; the optically detectable feature being disposed on a side of the capsule lid facing away from the flange; and the flange and the capsule lid being configured to be at least partially optically transparent.

The optically detectable feature can thus advantageously be disposed on a side of the lid film facing away from the base element, said side being particularly easy to imprint, for example. At the same time, however, reading the optically detectable feature is possible from the opposite side of the capsule, thus through the flange and the lid film, because the flange and the capsule lid are configured to be optically transparent at least in the region of the optically detectable feature. For example, the optically detectable feature can thus be read by a detector disposed on the side of the base element if said optically detectable feature is backlit from sides of the lid film, for example. In the context of the present invention, the wording optically transparent means in particular that the material is configured to be at least adequately permeable to light (also referred to as translucent or partially transparent) so that optical reading of the feature by a detector is made possible. Therefore, a transparency of 100% does in particular not have to be provided for all wavelengths of the optical spectrum.

Preferably, only a peripheral region of the capsule lid, or the entire capsule lid, is configured to be optically transparent. It is conceivable that a central region of the capsule lid, which does not cover the flange, is able to be imprinted in a known manner in an optically appealing way with a logo or an inscription or the like, while only the peripheral region of the capsule lid, in which the feature is disposed and which covers the flange, is configured to be optically transparent. Alternatively, the entire capsule lid is configured to be transparent.

An adhesive layer, by way of which the peripheral region and the flange are connected to one another in a materially integral manner, is preferably disposed between the peripheral region of the capsule lid and the flange, the adhesive layer being configured to be optically transparent. In this way, the feature can advantageously be optically read by the detector through the flange, the adhesive layer and the lid film.

The optically detectable feature in terms of a plane of main extent of the capsule lid is preferably disposed in a peripheral region of the capsule lid. This means that the feature, in particular when viewed in the radial direction, is disposed in an outer peripheral region of the preferably round capsule lid.

It is preferably provided that the single serve capsule has a ring, the optically detectable feature being disposed, in particular printed, on the ring, the ring being disposed on the capsule lid and in particular being adhesively bonded to the capsule lid.

It is preferably provided that the base element is configured to be completely optically transparent.

It is preferably provided that the base element is constructed in two parts, of a base part and a flange part, wherein only the flange part is configured to be optically transparent, wherein the base part and the flange part are connected to one another.

It is preferably provided that the optically detectable feature is a machine-readable code, preferably a one-dimensional or multi-dimensional bit code or bar code.

A further subject matter of the present invention is the use of the abovementioned single serve capsule according to the invention for preparing a beverage with the aid of a beverage preparation machine.

According to a preferred embodiment of the present invention it is provided that the base element is made of plastics material. The base element is preferably produced by cold or hot forming, in particular deep drawing. The design embodiment of the base element with a cavity is preferably generated by thermoforming, for example deep drawing by means of negative pressure, positive pressure and/or a movable ram. Alternatively, the single serve capsule is produced by means of injection molding methods, in particular by the single-component, multi-component or in-mold method.

The base element is preferably made of polyethylene (PE), polypropylene (PP), polyvinyl chloride (PVC), polymethyl methacrylate (PMMA), polycarbonate (PC), polystyrene (PS), polyphenylene ether (PPO) or polyethylene terephthalate (PET).

The lidding film is preferably made of polyethylene (PE), polypropylene (PP), polyvinyl chloride (PVC), polymethyl methacrylate (PMMA), polycarbonate (PC), polystyrene (PS), polyphenylene ether (PPO) or polyethylene terephthalate (PET).

It is conceivable that the lidding film and the base element are made of the same material.

The base element is preferably of a frustoconical, conical, cylindrical, spherical, hemispherical, elliptic, or partially elliptic configuration. The base element is preferably of a rigid or semi-rigid configuration. The cavity formed by the base element serves for receiving beverage raw material, for example roasted coffee granules, instant coffee, chocolate powder, tea blends, milk powder and/or the like. The lid film is in particular of a planer or almost planar configuration, at least immediately after closing the filled single serve capsule with the lid film. Any crownings of the lid film over time by gas emissions of coffee powder do not preclude the lid film being planar in the context of the present invention because these crownings typically occur only at some time after filling the single serve capsule.

The lid film preferably comprises a plastic/aluminum composite film, or a plastic film, or a multi-layer plastic film. It is conceivable that the single serve capsule is configured to be rotationally symmetrical about its longitudinal axis. The longitudinal axis thus forms a central axis of rotational symmetry which runs centrically through the single serve capsule and therefore, in particular, substantially perpendicularly to a plane of main extent of the lid film. The flange of the base element preferably runs at an angle between 70 and 110 degrees, particularly preferably from 80 to 100 degrees, and most particularly preferably of substantially 90 degrees, in relation to the axis of rotational symmetry. The flange is configured to be encircling, in particular closed in an encircling manner. The free outer end of the flange preferably has a bead, a flanging, or a so-called crimped rim, so as to avoid injury to the user on the sharp-edged end.

The single serve capsule can contain one or a plurality of beverage substances. The one or the plurality of beverage substances may be a liquid, a sirup, a solid, a powder, coffee or cocoa grounds, tea leaves, or a combination thereof. The one or the plurality of beverage substances can be diluted or extracted in a beverage preparation machine and/or a beverage system in order to prepare a beverage.

The single serve capsule can comprise each of the optically detectable features and/or elements described and/or depicted herein. Each of the features and/or elements described herein can be combined for producing a single serve capsule. Each of the features and/or elements described herein can be duplicated in order to produce a single serve capsule. Each of the features and/or elements described herein can be eliminated or omitted in order to produce a single serve capsule. Each of the features disclosed herein can be rearranged on each of the elements or surfaces listed herein. For example, a feature or element which is said to be located on the flange of the single serve capsule may additionally or alternatively be disposed on the lid or the base element.

The single serve capsule can have a body or a base element. The body or the base element can be a container, or form one or a plurality of cavities in which the beverage substance and/or one or a plurality of elements are received and/or stored. The body or the base element can have a lateral wall with radiused, curved or hemispherical surfaces. The body or the base element can have a lateral wall with rectilinear, flat or tapered faces. The body or the base element can have a lateral wall with surfaces that form a hemisphere, a dome, a cone, or a truncated cone. The base element can have a base area. The base area can be radiused or be hemispherical. The base area can be generally flat or planar. The base area can have one or a plurality of concavities. If the base has more than one depression, the two or more depressions can be concentric or lie in one another. The base area can be angled or inclined in relation to the lateral wall.

The single serve capsule can have a flange. The flange and the base element can be composed of one or a plurality of integral materials. The flange and the base element can be formed from one or a plurality of separate materials and then be connected to one another by a joining process. For example, the flange and the base element can be connected using an adhesive, a seal, or any other suitable connecting method. The flange can be composed of the same material as the base element and/or the lid. The flange can be composed of a different material than the base element and/or the lid. The flange can have an annular shape which extends at least partially about the entire circumference of the base element. In specific embodiments, the flange can however extend only about part of the circumference of the base element. In some cases, the flange can be composed of two or more tabs which extend from the base element. The flange can extend or project outward from the base element or the lateral wall of the base element. The flange can extend at an angle from the base element in such a way that an angle between the upper face of the flange and the lateral wall of the capsule is an acute angle (of less than 90 degrees). The flange can extend at an angle from the base element in such a way that an angle between the upper side of the flange and the lateral wall of the capsule is an obtuse angle (of less than 90 degrees). The flange can extend at an angle from the base element in such a way that an angle between the upper side of the flange and the lateral wall of the capsule is approximately a right angle (of approximately 90 degrees).

The flange can be located on the upper side of the base element. The flange can be located on the lower side of the base element. The flange can be located in a region between the lower surface and the lower surface of the base element. The flange can be located closer to the upper side than the lower side of the base element, or vice versa.

The single serve capsule can be provided with a lid (also referred to as the capsule lid). The lid can close or seal the cavity or the base element once the beverage ingredient has been added or incorporated in the cavity. The lid can generate an air-tight or hermetic seal so as to maintain the freshness of the beverage ingredient. The lid can cause a seal that is not air-tight or hermetic. The lid can generate a seal in such a way that air and moisture can be prevented from invading the cavity or the capsule, and/or from leaving the latter. The lid can be fastened to the single serve capsule, to the base element, to the upper side of the base element, to the lower side of the base element, to the flange, to the upper side of the flange, to the lower side of the flange, or to a combination thereof. The lid can be attached by adhesive bonding, welding, or any other suitable fastening method or device. The lid can be composed of the same material as the base element and/or the flange. The lid can be produced from a different material than the base element and/or the flange. The lid, the flange and/or the base element can be composed of one or a plurality of integral materials. The lid, the flange and/or the base element can be composed of one or a plurality of separate materials and then be connected to one another by a joining process. For example, the lid, the flange and/or the base element can be connected using an adhesive, a seal, a welding method, or any other suitable connecting method.

The single serve capsule, the body or the base element, the flange and/or the lid can be composed of a material which is suitable for preparing a beverage and/or for storing ingredients for the beverage preparation. The single serve capsule, the base element, the flange and/or the lid can be produced from a non-metallic material. The single serve capsule, the base element, the flange and/or the lid can be produced from a recycled material. The single serve capsule, the base element, the flange and/or the lid can be produced from a recyclable material. The single serve capsule, the base element, the flange and/or the lid can be produced from a biologically decomposable material. The single serve capsule, the base element, the flange and/or the lid can be produced from a paper material. The single serve capsule, the base element, the flange and/or the lid can be produced from a compostable material. The single serve capsule, the base element, the flange and/or the lid can be produced from a cellulosic material. The singe serve capsule, the base element, the flange and/or the lid can be produced from a material containing polylactic acid. The single serve capsule, the base element, the flange and/or the lid can be produced from a material which is more or less resistant to deformation, decomposition and collapsing at temperatures of up to at least 120° C. The single serve capsule, the base element, the flange and/or the lid can be produced from a material harvested from corn. The single serve capsule, the base element, the flange and/or the lid can be produced from a plant-based material. The single serve capsule, the base element, the flange and/or the lid can be produced from a material which is free of polystyrene. The single serve capsule, the base element, the flange and/or the lid can be produced from a food-safe material. The single serve capsule, the base element, the flange and/or the lid can be produced by injection-molding, thermoforming, drawing, or the like. The base element, the flange and/or the lid can be laminated. The single serve capsule, the base element, the flange and/or the lid can be produced from an electrically conductive material. The single serve capsule, the base element, the flange and/or the lid can be produced from an electrically non-conducting material. The single serve capsule, the base element, the flange and/or the lid can be produced from a woven fabric material. The single serve capsule, the base element, the flange and/or the lid can be produced from a rubber material. The single serve capsule, the base element, the flange and/or the lid can be produced from a plastics material. The single serve capsule, the base element, the flange and/or the lid can be produced from aluminum. The single serve capsule, the base element, the flange and/or the lid can be composed of a material that is elastic or deformable. The base element, the flange and/or the lid can be composed of a deformable material which can withstand various liquid temperatures (hot and cold) and pressures without being damaged (i.e. without the base element, the flange and/or the lid rupturing or breaking in undesirable regions). The single serve capsule, the base element, the flange and/or the lid can have generally identical wall thicknesses. The single serve capsule, the base element, the flange and/or the lid can have different wall thicknesses. For example, the single serve capsule, the base element, the flange and/or the lid can have a thicker wall thickness in specific regions so as to prevent destruction of the single serve capsule during handling and/or use.

The single serve capsule can have one or a plurality of capsule features. The one or the plurality of capsule features can be one or a plurality of protrusions, ridges, elevations and/or convexities which extend away from the external face of the base element, or protrude beyond the latter. The one capsule feature, or the capsule features, can be one or a plurality of channels, grooves, depressions, troughs or concavities which extend from the external face into the base element, or project into the latter. The one capsule feature, or the capsule features, can extend about the entire circumference of the body or of the base element. The one capsule feature, or the plurality of capsule features, can also extend only about part, or a region, of the circumference of the body or of the base element. The one surface capsule feature, or the plurality of surface capsule features, can extend continuously about the body or the base element. The one capsule feature, or the plurality of capsule features, can extend in an intermittent manner (beginning and end) about the body or the base element. The one capsule feature, or the plurality of capsule features, can be located only on the base element. The one capsule feature, or the plurality of capsule features, can be located only on the lid. The one capsule feature, or the plurality of capsule features, can be disposed only on the flange. The one capsule feature, or the plurality of capsule features, may not be located on the bode, the flange, the lid, or a combination thereof. The one capsule feature, or the plurality of capsule features, can be located on the internal face of the base element. The one capsule feature, or the plurality of capsule features, can be disposed on the external face of the base element. The one capsule feature, or the plurality of capsule features, can be disposed on the upper side of the flange, the lower side of the flange, the lateral face of the flange, or a combination thereof. The one capsule feature, or the plurality of capsule features, can be one or a plurality of rings which extend about the entire circumference, or part of the circumference, of the single serve capsule. The one or the plurality of features of the single serve capsule can be diagonal, or extend along a diagonal or at an angle relative to a central longitudinal axis of the single serve capsule. The one capsule feature, or the plurality of capsule features, can have irregular shapes such as scrolls and twirls. The one capsule feature, or the plurality of capsule features, can be vertically aligned (from the upper side to the lower side of the base element). The one capsule feature, or the plurality of capsule features, can extend on the flange (upper side, lower side and/or lateral face of the flange). The one capsule feature, or the plurality of capsule features, may not extend on the flange. The one capsule feature, or the plurality of capsule features, can extend from the flange to the base area of the base element. The one capsule feature, or the plurality of capsule features, can extend from the flange in the direction of the base area of the base element, but must not extend to the base area. The one capsule feature, or the plurality of capsule features, can extend from the lower surface of the base element to the upper surface of the base element, but must not extend to the upper surface. The spacing between the adjacent capsule features can be uniform. In other words, the spacing between some or all capsule features can be substantially identical. The spacing between adjacent capsule features can be dissimilar. In other words, the spacing between some or all capsule features can be dissimilar. The one capsule feature, or the plurality of capsule features, can have a zebra shape, or a printed zebra pattern. This can mean that the one capsule feature, or the plurality of capsule features, extend along at least part of the (or the entire) body or base element, lid and/or flange. The one capsule feature, or the plurality of capsule features, can fade or be less visible in specific regions, while they are more intense or better visible in other regions. For example, the visibility of the one capsule feature, or of the plurality of capsule features, can vary. For example, the depth of a depression or groove may become flatter or deeper in specific regions of the base element, of the lid and/or of the flange. For example, the height or the protrusion of a rib or of a ridge may be larger or smaller in specific regions of the base element, of the flange and/or of the lid than in other regions of the base element, of the flange and/or of the lid.

The one capsule feature, or the plurality of capsule features, can be located only on the external face of the lateral wall or of the body. The one capsule feature, or the plurality of capsule features, can be located only on the internal face of the lateral wall or of the body. The one capsule feature, or the plurality of capsule features, can be located on the internal face as well as on the external face of the lateral wall or of the body. The one capsule feature, or the plurality of capsule features, located on the external surface, can correspond to the one capsule feature, or the plurality of capsule features, located on the internal face of the capsule body. For example, a groove on the external face of the capsule body can form a rib or a protrusion on the internal face of the lateral wall, or vice versa. For example, a groove on the upper side of the flange or lid can form a rib or a protrusion on the lower side of the flange or lid, or vice versa.

The one capsule feature, or the plurality of capsule features, located on an internal face or in the interior of the cavity can serve for varying or interrupting the liquid stream of the beverage into and/or through the base element. The one capsule feature, or the plurality of capsule features, can serve to cause or generate a turbulent liquid stream into and/or through the capsule. The one capsule feature, or the plurality of capsule features, can serve to cause or generate a laminar liquid stream into and/or through the capsule. The one capsule feature, or the plurality of capsule features, can serve to cause the liquid to swirl into and/or through the capsule. The one capsule feature, or the plurality of capsule features, can cause the liquid flowing in and through the capsule to move upward and/or downward so as the extract and/or dissolve the beverage component in the capsule.

The single serve capsule can be coated with an ink, with a material that imparts a metallic appearance to the single serve capsule and can be produced from an ink or metallic flakes or metallic particles or pigments. The particles can be suspended or dispersed in an aqueous medium and then be applied to the base element, the lid and/or the flange. In order to provide the metallic appearance, it is possible that the particles or pigments are incorporated in the plastics material when the plastics material is in a fused or softened state. For example, an aluminum flake material can be added to the plastics material so as to impart the latter a unique appearance, and/or to hide production swirls or defects which as a result of

The one capsule feature, or the plurality of capsule features, can be configured integrally on the capsule body or the base, the lid and/or the flange. The one capsule feature, or the plurality of capsule features, can be added to the capsule body or the base, the lid and/or the flange. The one capsule feature, or the plurality of capsule features, can be printed on or attached to the capsule body or the base, the lid and/or the flange. The one capsule feature, or the plurality of capsule features, can be molded or produced from the same material as the capsule body, the flange and/or the lid. The one capsule feature, or the plurality of capsule features, can be molded or produced from a different material than the capsule body, the flange and/or the lid.

The one capsule feature, or the plurality of capsule features, can be printed, embossed, etched, adhesively bonded or attached on or to the capsule body, the flange and/or the lid.

The one capsule feature, or the plurality of capsule features, can be adhesively bonded or welded to the capsule base, or fastened to the latter in another way.

The one capsule feature, or the plurality of capsule features, can also be the one or the plurality of optically identifiable features. In this context, the one capsule feature, or the plurality of capsule features, can serve for one or a plurality of purposes or functions disclosed herein. Alternatively, the one capsule feature, or the plurality of capsule features, can fulfil only the function or the purpose of an optically identifiable feature.

The single serve capsule can have one or a plurality of optically identifiable features. The one optically identifiable feature, or the plurality of optically identifiable features, can be located on the singe serve capsule, the body or the base element, the lateral wall, the external face of the lateral wall, the internal face of the lateral wall, the flange, the upper side of the flange, the lower side of the flange, the lateral face of the flange, the lid, the upper side of the lid, the lower side of the lid, the lateral face of the lid, or a combination thereof.

The one optically detectable feature, or the plurality of optically detectable features, can be read, detected, recognized and/or identified by one or a plurality of detectors of the beverage machine and/or of the system. The one detector, or the plurality of detectors, can be one or a plurality of lasers, lights, light curtains, scanners, readers, eyes, cameras, bar code readers, bit code readers, or a combination thereof. Once the single serve capsule has been introduced into the beverage machine, the one or the plurality of detectors can be disposed above the single serve capsule, below the single serve capsule, beside the single serve capsule, or a combination thereof. The one detector, or the plurality of detectors, can contain one or a plurality of processors, memories, programs, hard drives, RAMs, or other computer hardware and software, or be electronically connected thereto. The one detector, or the plurality of detectors, can function in such a way that they read or identify the one or the plurality of optically identifiable features, and/or correlate the latter with one or a plurality of stored references. One of the read optically identifiable feature, or a plurality of the read optically identifiable features, can be stored on a hard drive, in a memory, or in a cloud of the detector, of the beverage machine, or in both. The one detector, or the plurality of detectors, can function in such a way that they read or identify the one or the plurality of optically identifiable features, and/or correlate the latter with one or a plurality of stored references so as to determine the type of single serve capsule. For example, the one detector, or the plurality of detectors, can recognize whether the single serve capsule contains coffee, expresso, cocoa, alcoholic or non-alcoholic beverage ingredients, or ingredients for cleaning the machine. For example, the one detector, or the plurality of detectors, can recognize whether the single serve capsule requires warm, cold or ambient water, or any other liquid (milk, juice, etc.), in order to prepare the desired beverage. For example, the detector or detectors can ascertain the machine parameters for preparing the desired or intended beverage, such as, for example, the liquid temperature, the liquid pressure, the liquid quantity, the heating or cooling time and/or temperature, whether additional ingredients or liquids have to be mixed with the beverage, or whether said additional ingredients or liquids have to run through the single serve capsule. The one detector, or the plurality of detectors, can be capable of identifying the machine parameters for cleaning the beverage machine when the detector recognizes that the capsule is specified for cleaning the machine. The one detector, or the plurality of detectors, can function in such a way that they recognize an incompatible optically detectable feature when a single serve capsule that is not intended for use in the machine is introduced into the machine. This can advantageously prevent errors from occurring, the machine being damaged, and/or an operator or bystander being injured.

The one optically identifiable feature, or the plurality of optically identifiable features, can be one or more of the following: colors, patterns, logos, bar codes (two-dimensional and/or three-dimensional), bit codes, binary codes, depressions, notches, elevations, protrusions, elevations. The one optically identifiable feature, or the plurality of optically identifiable features, can be visible to the human eye. The one optically identifiable feature, or the plurality of optically identifiable features, can be invisible to the human eye. The one optically identifiable feature, or the plurality of optically identifiable features, can comprise ribs, protrusions, elevations, studs, spacers, barbs, openings, holes, depressions, grooves and depressions. The one optically identifiable feature, or the plurality of optically identifiable features, can be one or a plurality of images, lines or grooves. The one optically identifiable feature, or the plurality of optically identifiable features, can be flat or one-dimensional. The one optically identifiable feature, or the plurality of optically identifiable features, can be three-dimensional.

The beverage machine can contain one or a plurality of detectors. The one detector, or the plurality of detectors, can be electrically connected (by wire or wirelessly) to a system network. The one detector, or the plurality of detectors, can transmit information pertaining to the use of the single serve capsule in the machine to the system network. The items of information can be collected from one or a plurality of optically identifiable features and/or the machine and then be transmitted to a system network. The items of information collected and transmitted can assist a supplier or manufacturer of the single serve capsule and/or machines, or assist a service technician, to identify issues with the single serve capsule and/or the machine. The items of information collected and transmitted can assist a supplier or manufacturer of the single serve capsules and/or machines in predicting the habits of the consumers, in determining the consumption, in raising orders, in managing the stock, in establishing a customer loyalty program, in collecting data pertaining to consumer preferences, in generating and analyzing data, in predicting production, manufacture and shipping based on the consumption of the consumers. The system network may be located anywhere in the world, including the same state or country as the beverage machine and/or the user, or in a different state or country.

The present teaching provides a method for recycling and/or composting a single serve capsule, the lid, the filter, or a combination thereof. The method can comprise the severing or one or a plurality of elements (if present) from the single serve capsule, the severing of the lid from the single serve capsule, and the composting of one or a plurality of the base elements and/or the lid. The method can comprise a step of composting the entire single serve capsule including the lid, the filter (if present) and/or the base.

Further details, features and advantages of the single serve capsule are derived from the drawings and from the description hereunder of preferred embodiment by means of the drawings. The drawings herein only illustrate exemplary embodiments of the single serve capsule that do not limit the substantial concept of the invention.

### BRIEF DESCRIPTION OF THE DRAWINGS

FIG. 1a shows a schematic sectional view of a single serve capsule according to an exemplary embodiment of the present invention;

FIG. 1b shows a schematic plan view “from above” of the single serve capsule according to the exemplary embodiment of the present invention;

FIG. 1c shows a schematic plan view “from below” of the single serve capsule according to the exemplary embodiment of the present invention.

### DETAILED DESCRIPTION

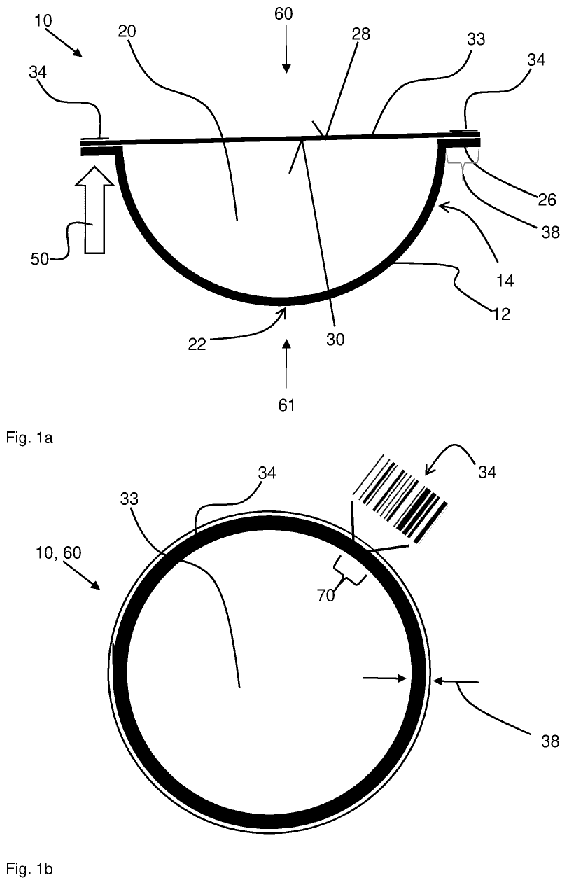

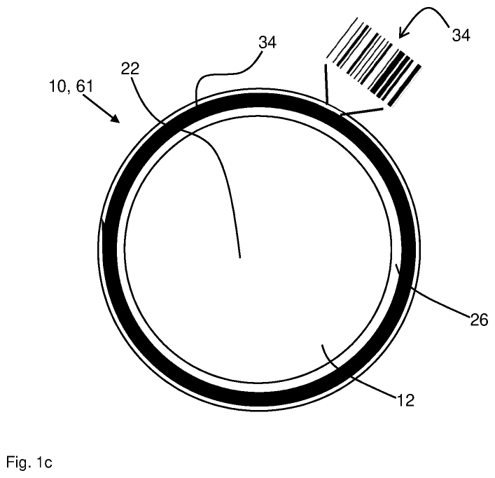

Disclosed in FIG. 1a is a schematic lateral view of a single serve capsule 10 for preparing a beverage.

The single serve capsule 10 has a base element 12 (also referred to as the body). The body, or the base element 12, comprises a lateral wall 14 (also referred to as the capsule wall). The lateral wall 12 extends from a base region 22 (also referred to as the capsule base) to an encircling flange 26 which projects laterally and is in particular configured to be encircling. The base element 12 defines a cavity 20 which is provided for receiving beverage raw material. The base element, on the side facing away from the base region 22, has a filling opening through which the cavity 20 is able to be filled with the beverage raw material.

By way of example, the single serve capsule 10 has a spherically configured base element 12 which on the closed side thereof has the capsule base 22 (which may be configured to be convex and does not at all have to be configured to be planar), and on the open side thereof has an encircling flange 26. Between the capsule base 22 and the flange 26, the capsule wall 14 extends about the cavity 20. The single serve capsule 10 is constructed to be rotationally symmetrical about its centric central longitudinal axis. The flange 26, which is configured to be annular and thus to be encircling in the circumferential direction, projects outward beyond the capsule wall 14 in the radial direction in relation to the centric rotational symmetry axis.

The flange 26 is fixedly connected to a capsule lid 33 (also referred to as the lid or membrane) in the form of an in particular annular lid film which closes the cavity 20 on the open side of the base element 12. For this purpose, the flange 26 preferably has a sealing plane which faces the capsule lid 33 and extends approximately perpendicularly to the rotational symmetry axis. The capsule lid 33 in its peripheral region is sealed, welded or adhesively bonded to the flange 26, in particular to the sealing plane.

Configured within the base element 12 is the cavity 20 which is filled with the beverage raw material, for example roasted coffee granules, instant coffee, chocolate powder, tea blend, milk powder and/or the like (not illustrated for reasons of clarity) and is closed by the capsule lid 33.

The single serve capsule 10 is provided to be introduced into a brewing unit of a beverage preparation machine in order to prepare a beverage. The brewing unit comprises a first brewing chamber part and a second brewing chamber part, wherein the first or the second brewing chamber part is movable, in particular pivotable or displaceable, relative to the other brewing chamber part, between a converged position in which the first and the second brewing chamber part form a closed brewing chamber, and an open position in which the first and the second brewing chamber part are mutually spaced apart in order for the single serve capsule 10 to be inserted or ejected.

In the closed position, the capsule lid 33 and/or the capsule base 22 are perforated so as to generate perforation openings for incorporating brewing liquid, or for discharging the prepared beverage. The pressurized brewing liquid is directed into the cavity 20. The desired beverage is created as a result of the interaction between the brewing liquid and the beverage raw material, said desired beverage exiting the single serve capsule 12 through the perforation openings and being fed to a beverage vessel. Any potential particles of the beverage raw material can be filtered from the beverage and retained in the single serve capsule 10 by an optional filter medium. However, the capsule lid 33 with multiple perforations preferably functions as a filter element.

The single serve capsule 10 now in particular has a feature 34 which is optically detectable by a detector of the beverage preparation machine. This feature 34 preferably serves for identifying the single serve capsule 10 in the beverage preparation machine or for controlling brewing parameters. In this way, it can be verified by the beverage preparation machine whether, for example, the single serve capsule 10 located in the brewing chamber is a system-compatible single serve capsule 10 and/or a matching brewing program can be automatically selected and started for the beverage raw material located in the single serve capsule 10. It is also conceivable that brewing parameters which are to be used specifically are embedded in the optically detectable feature 34, and are read by means of the detector.

The optically detectable feature 34 is in particular a machine-readable code applied to the lid film 33 in the form of a one-dimensional or multi-dimensional bit code or bar code. The bit code or bar code herein is configured to be completely or partially encircling as a circle or partial circle about the rotational symmetry axis of the single serve capsule 10. The individual adjacent lines from which the in particular two-colored or multi-colored bit code or bar code is constructed in this instance preferably extend in the radial direction in terms of the rotational symmetry axis. The code here is applied to an upper side 28 of the lid film 33 facing away from the flange 26. The code here is in particular located in an encircling peripheral region 38 of the lid film 33, wherein in particular that part of the lid film 33 that is fastened to the flange 26 and/or is in contact directly with the flange 26 is referred to as the peripheral region 38.

The code here is either imprinted directly on the upper side 28 in the peripheral region, or applied to a ring (not illustrated) which is adhesively bonded to the upper side 28.

In order for the code to be readable by a detector of the beverage preparation machine, which detector is directed “from below”, thus along a direction from the base element 12 in the direction of the lid film 33, in particular parallel to the rotational symmetry axis (illustrated by the arrow 50), onto the flange 26 of the single serve capsule 10, the lid film 33 is configured to be transparent at least in the peripheral region 38, and the capsule body 12 is configured to be transparent at least in the region of the flange 26. The wording optically transparent means that the materials are configured to be permeable to light (also referred to as translucent or partially transparent) at least to the extent that the detector can optically read the code. For this purpose, the code can be backlit in the beverage preparation machine.

It is conceivable that the entire lid film 33 is configured to be transparent, or only in the peripheral region, so that imprinting the lid film with a logo, product descriptions, inscriptions and the like is possible in a central region lying in the radial direction within the peripheral region 38.

Likewise, either the entire base element 12, or only the flange 26 of the base element 12, can be configured to be transparent.

In order to achieve an at least partially optically transparent base element 12 and an at least partially optical transparent lid film 33, the base element 12 and the lid film 33 are preferably made of polyethylene (PE), polypropylene (PP), polyvinyl chloride (PVC), polymethyl methacrylate (PMMA), polycarbonate (PC), polystyrene (PS), polyphenylene ether (PPO), or polyethylene terephthalate (PET). The pot-shaped or spherical design embodiment of the base element 12 is preferably generated by thermoforming, for example deep drawing by means of negative pressure, positive pressure and/or a movable ram. Alternatively, the single serve capsule 10 is produced by means of injection-molding methods, in particular by the single-component, multi-component or in-mold method. As a further alternative, it would be conceivable for the base element 12 to be produced completely or partially from a biologically decomposable material, in particular from cellulose fibers which may be embedded in a resin matrix.

Illustrated in FIG. 1b is a schematic plan view “from above” of the single serve capsule 10 according to the exemplary embodiment of the present invention. The plan view is performed along the arrow 60 shown in FIG. 1a. To this extent, the view is onto the upper side 28 of the lid film 33, and the code which is applied to the lid film 33 and represents the optically detectable feature 34 can be seen here.

A sub-region 70 of the code is enlarged and illustrated by way of example so as to illustrate the bit code or bar code. It can be seen that this, by way of example, is a bit code or bar code with quasi-parallel lines in the radial direction.

Illustrated in FIG. 1c is a schematic plan view “from below” of the single serve capsule according to the exemplary embodiment of the present invention. The plan view is performed along the arrow 61 shown in FIG. 1a. To be seen in this perspective are in particular the capsule body 12 and the flange 26. Owing to the fact that at least the flange 26 is configured to be transparent, the view here is onto a lower side 30 of the lid film 33, opposite the upper side 28. However, because at least the peripheral region 38 of the lid film 33 is also configured to be optically transparent, the code can also be seen “from below” through the flange 26 and the lid film 33 in this perspective through the lid film 33, so that the detector can also read the code from this perspective (see arrow 50 in FIG. 1a).

### LIST OF REFERENCE NUMERALS

10 Single serve capsule
12 Base element
14 Lateral wall of the base element
20 Cavity for beverage raw material
22 Base area of the base element
26 Flange of the base element
28 Upper side of the lid film
30 Lower side of the lid film
33 Capsule lid/lid film
34 Optically detectable feature
38 Peripheral region of the lid film
50 Detection direction of a detector
60 View “from above”
61 View “from below”
70 Partial area of the code

1. A single serve capsule for preparing a beverage with aid of a beverage preparation machine, the single serve capsule having a base element with a cavity for receiving a beverage raw material and a capsule lid which closes the cavity; the base element comprising a capsule base, an encircling flange, and a capsule wall which extends from the capsule base to the encircling flange; the capsule lid being fastened to the flange; the single serve capsule having an optically detectable feature which is optically detectable by a detector of the beverage preparation machine; the optically detectable feature being disposed on a side of the capsule lid facing away from the flange, wherein the flange and the capsule lid are configured to be optically transparent at least in a region of the optically detectable feature.

2. The single serve capsule as claimed in claim 1, wherein only a peripheral region of the capsule lid, or an entirety of the capsule lid is optically transparent.

3. The single serve capsule as claimed in claim 2, wherein an adhesive layer is disposed between the peripheral region of the capsule lid and the flange by way of which the peripheral region and the flange are connected to one another in a materially integral manner, the adhesive layer being configured to be optically transparent.

4. The single serve capsule as claimed in claim 1, wherein the optically detectable feature is disposed in a peripheral region of the capsule lid relative to a plane of main extent of the capsule lid.

5. The single serve capsule as claimed in claim 1, wherein the single serve capsule has a ring, the optically detectable feature being printed on the ring, the ring being disposed on the side of the capsule lid facing away from the flange, the ring is adhesively bonded to the capsule lid, the ring is optically transparent.

6. The single serve capsule as claimed in claim 1, wherein the base element is completely optically transparent.

7. The single serve capsule as claimed in claim 1, wherein the base element is constructed in two parts, of a base part and a flange part, only the flange part is optically transparent, the base part and the flange part being connected to one another.

8. The single serve capsule as claimed in claim 1, wherein the optically detectable feature is a machine-readable code or is a one-dimensional or multi-dimensional bit code or bar code.

9. Use of the single serve capsule as claimed in claim 1, for preparing the beverage with the aid of the beverage preparation machine.
